(19) United States
(12) Patent Application Publication
(10) Pub. No.: US 2025/0106826 A1
(43) Pub. Date: Mar. 27, 2025

(54) IMPLEMENTATION OF SUB-BAND FULL DUPLEXING IN A CELLULAR NETWORK

(71) Applicants: Centre of Excellence in Wireless Technology, Chennai, Tamil Nadu (IN); Indian Institute of Technology Madras (IIT Madras), Chennai, Tamil Nadu (IN)

(72) Inventors: Priyanka DEY, Chennai, Tamil Nadu (IN); Deepak Padmanabhan MAYA, Chennai, Tamil Nadu (IN); Abhijeet Abhimanyu MASAL, Chennai, Tamil Nadu (IN); Dhivagar BASKARAN, Chennai, Tamil Nadu (IN); Pardhasarathy JYOTHI, Chennai, Tamil Nadu (IN); Jeniston Deviraj Klutto MILLETH, Chennai, Tamil Nadu (IN); Bhaskar RAMAMURTHI, Chennai, Tamil Nadu (IN)

(21) Appl. No.: 18/835,232

(22) PCT Filed: Feb. 3, 2023
(86) PCT No.: PCT/IN2023/050107

§ 371 Date: Aug. 1, 2024

(30) Foreign Application Priority Data
Feb. 3, 2022 (IN) 202241005849

(51) Int. Cl. H04W 72/0446; H04L 5/00; H04L 5/14; H04W 72/231

(52) U.S. Cl. CPC H04W 72/0446; H04L 5/0048; H04L 5/14; H04W 72/231

(57) ABSTRACT

A method of signalling in a cellular network is described. The method comprises allocating, by a first node, a first resource to a second node. The method further comprises configuring, by the first node, to perform at least one first operation by the at least one second node in the at least one first resource. The method further comprises configuring, by the first node, a second resource. The method further comprises configuring by the first node, to perform a second operation by the second node in the second resource. The second operation overrides the first operation in an overlapping portion of the first resource and the second resource.

### FIELD OF THE INVENTION

The present disclosure relates generally to a cellular network, and more particularly to a method of implementing Sub-Band Full Duplexing in a cellular network.

### BACKGROUND OF THE INVENTION

Wireless communication systems are widely deployed to provide various telecommunication services such as telephone, video, data, messaging, and broadcasts. Typical wireless communication systems employ multiple-access technologies capable of supporting communication with multiple users by sharing available system resources. Examples of such multiple-access technologies include Code Division Multiple Access (CDMA) systems, Time Division Multiple Access (TDMA) systems, Frequency Division Multiple Access (FDMA) systems, Orthogonal Frequency Division Multiple Access (OFDMA) systems, Single-Carrier Frequency Division Multiple Access (SC-FDMA) systems, and Time Division Synchronous Code Division Multiple Access (TD-SCDMA) systems.

The telecommunication standards provide a common protocol for enabling different wireless devices to communicate on a larger level. A recent addition to the list is the 5^{th} Generation (5G) New Radio (NR), which is part of a continuous mobile broadband evolution promulgated by the Third Generation Partnership Project (3GPP) to meet new requirements associated with latency, reliability, security, and scalability. 5G NR includes provisions associated with enhanced mobile broadband (eMBB), massive machine type communications (mMTC), and ultra-reliable low latency communications (URLLC). Some aspects of 5G NR may be based on the 4G Long Term Evolution (LTE) standard. The multiple access technologies, mentioned above, are utilized in various telecommunication standards to improve spectral efficiency and data throughput. However, these schemes ensure orthogonality between the resources, used for transmissions and receptions at a node, in one or more of time, frequency and code domains. The orthogonality minimizes the interference and associated degradation. An alternate approach is full duplexing (FD), where a node performs transmission and reception in same time and frequency resources. The advantage with FD scheme is significant improvement in spectral efficiency and data throughput compared to the above mentioned multiple access technologies. However, advanced interference cancellation techniques are needed to overcome the performance degradation caused by interference.

Sub-Band Full Duplexing (SBFD) is a technique in which a node such as a Base Station (BS) transmits and receives data packets in fully overlapping, partially overlapping, or orthogonal frequency resources or sub-bands, in same time resources. As illustrated in FIG. 1, a BS performs Uplink (UL) operation in sub-band 1 of time slot 1 and performs Downlink (DL) operation in sub-band 2 of same time slot i.e. time slot 1. Further, the BS performs the DL operation in sub-band 1 of time slot 2 and performs the UL operation in sub-band 2 of same time slot i.e. time slot 2. The sub-bands are defined in terms of resource elements (REs), groups of REs, resource blocks (RBs), resource block groups (RBG), or bandwidth parts (BWP) in frequency domain. As illustrated in FIG. 2, two REs 202 and 204 are configured as UL resource and rest of the REs in the same time resource are configured as DL resource. FIG. 3 illustrates SBFD operation in fully and partially overlapping sub-bands. In FIG. 3 for the case of partial overlap between subbands, the resources 304 is configured for UL operation, the resources 302 is configured for DL operation and the band 306 is configured for both DL and UL operations.

Implementing SBFD can create conflicts among various signals and channels in the system. For e.g., the BS configures Channel State Information-Reference Signal (CSI-RS) reception to the UE so that UE can measure the parameters of the channel. The CSI-RS is a wide band signal than span across the bandwidth part (BWP) of the UE and its configuration is provided semi-statically. If a sub-band configured for UL operation in SBFD overlaps with the BWP of the UE, then there is a possibility that the resources configured for CSI-RS receptions within the BWP of the UE overlaps with the UL sub-band. Hence, resulting in conflict between CSI-RS reception of one UE and UL configuration of another UE. For example, resources configured for CSI-RS reception at one UE overlaps with UL sub-band, which is configured for Physical Uplink Shared Channel (PUSCH) transmission at another UE. However, the BS must make sure that UL operation is avoided in the REs carrying CSI-RS to maintain orthogonality for non-overlapping or partially overlapping SBFD. Similarly, Sounding Reference Signal (SRS) is a wide band reference signal that span across the UL BWP of the UE. When UL BWP of the UE overlaps with DL sub-band configured for another UE, then the SRS can collide with DL operation configured for another UE in DL sub-band. For example, same resources can be configured for SRS transmission at one UE and Physical Downlink Shared Channel (PDSCH) reception at another UE. In conventional method, the collision is avoided using rate matching, where the BS provides rate matching patterns to the UE and the UE sip the resources indicated in the rate matching pattern. However, the existing rate matching patterns are not sufficient in case of collisions in SBFD. E.g., rate matching pattern between CSI-RS and PDSCH is not defined in NR. Hence, new rate matching patterns need to be defined.

The BS may have several types of architectures for implementation of the SBFD. In a first type of architecture, the BS may utilize same set of antennas for UL and DL. In a second type of architecture, the BS may utilize different sets of antennas for UL and DL. The second type of architecture may provide spatial isolation between DL and UL for reducing interference, such as adjacent channel leakage from the DL to UL resources at the BS. Further, reciprocity assumptions between DL and UL does not hold true as the panels used are different. The reduction of interference may impact on the path loss measurement done by the UE for UL power control. In conventional method utilized in NR, the pathloss is measured on a DL reference signal (e.g., CSI-RS/synchronization signals) and the value is used in the UL power control equation for PUSCH and physical uplink control channel (PUCCH). The conventional method works since reciprocity holds good between DL and UL paths. However, the conventional method does not work in case the BS uses different panels for UL and DL.

In cellular network, the User Equipments (UEs) are attached to at least one cell of a BS and the BS provide time division duplexed (TDD) configurations to the UEs that indicate the direction of operation in a time resource. In current framework, the BS provides a common cell-specific TDD configuration to all UEs within a cell. In the common cell-specific TDD configuration, the BS indicates a number of slots and/or symbols at the start of the frame that are configured as DL resources, and a number of slots and/or symbols at the end of the frame that are configured as UL resources. The remaining slots and/or symbols of the frame are configured as flexible (F) resources. Further, the BS provides UE specific TDD configuration to the UEs that will configure the slots and/or symbols in a frame, configured as F resources, as DL or UL. The slots and/or symbols in a frame, configured as F resources after common cell-specific TDD configuration and UE specific TDD configuration, are configured as DL or UL using Slot Format Indicator (SFI) in Downlink Control Information (DCI). Here, the configuration using common cell-specific TDD configuration and UE specific TDD configuration is semi-static and the configuration using DCI is dynamic. FIG. 4 illustrates TDD configurations to be provided to the UEs by the BS.

In the current framework, the common cell-specific TDD configuration is provided to all UEs in a cell and the common cell-specific TDD configuration cannot be overwritten by the UE specific TDD configuration and SFI. The BS cannot configure one UE as UL and another UE as DL in a resource configured using common cell-specific TDD configuration. Therefore, the BS can perform the SBFD only in the F resources provided by the common cell-specific TDD configuration. For e.g., a slot/symbol configured as DL in common cell-specific TDD configuration cannot be reconfigured as UL in UE specific TDD configuration or SFI. For example, as illustrated in FIG. 4, the SBFD operation is limited to a middle portion 402 of a frame. The middle portion 402 of the frame is configured by dedicated TDD and SFI format.

The BS may assign BWPs to UEs in a UE specific way. Multiple BWPs may be assigned to a UE in Radio Resource Control (RRC) message. Out of the multiple BWPs, one BWP may be active for a UE at a given instant of time. The BS may signal the UE to dynamically switch from active BWP to another BWP from the multiple BWPs assigned to the UE in RRC message. In conventional method, BS provide only a single TDD configuration to the UE and is applicable for all the BWPs configured. If BS indicates BWP switch, then the UE will switch the BWP. However, the TDD configuration will remain the same for the new BWP. This mechanism is not efficient for efficient implementation of SBFD, as the BS might need to change the TDD configuration along with the BWP dynamically. E.g., UE1 has active BWP1 when the BS is operating in non-SBFD mode. Now, the BS wants to operate in SBFD mode and for that purpose, the BS needs to switch the active BWP of UE1 to BWP2 with a different new TDD configuration to accommodate other UEs with different TDD configurations within the same band. This new TDD configuration is to allow the BS to efficiently operate SBFD in the network. Currently in NR, to do this, the BS has to provide a new TDD configuration using RRC message, which is semi-static in nature and involves certain delay.

The BS may configure the UE using RRC message for grant free transmission and the activation or de-activation using DCI scrambled with Configured Scheduling-Radio Network Temporary Identifier (CS-RNTI). In the NR, Frequency Domain Resource Assignment (FDRA) may be provided to the UE by DCI for a particular grant free transmission ID. The UE may transmit the PUSCH with the given periodicity and resource assignment when the FDRA is activated. In the conventional method the configuration (e.g., periodicity and FDRA) cannot be changed dynamically once activation command is given. However, in case of SBFD the configuration can vary dynamically. For e.g., the periodicity of transmission may be reduced in the SBFD operation since the BS can provide UL resources more frequently in time. Further, these UL resources might increase or decrease in frequency domain dynamically due to changes in sub-band sizes.

Thus, there is a need of new methods and signaling exchanges in order to mitigate the shortcoming of conventional methods of implementing SBFD in the cellular network.

### OBJECTS OF THE INVENTION

A general objective of the present invention is to provide a method of implementing Sub-Band Full Duplexing (SBFD) in a cellular network.

Another objective of the present invention is to provide enhancements to the resource configuration for efficient implementation of SBFD.

Yet another objective of the present invention is to provide a method for collision handling of channels or signals for efficient implementation of SBFD.

Yet another objective of the present invention is to provide a method for enhancement to channel measurement and reporting for efficient implementation of SBFD.

### SUMMARY OF THE INVENTION

The summary is provided to introduce aspects related to signalling in a cellular network, and the aspects are further described below in the detailed description. This summary is not intended to identify essential features of the claimed subject matter nor is it intended for use in determining or limiting the scope of the claimed subject matter.

The present invention relates to a method of signalling in a cellular network. The method may comprise allocating, by at least one first node, at least one first resource to at least one second node. The method may further comprise configuring, by the at least one first node, to perform at least one first operation by the at least one second node in the at least one first resource. The method further comprise configuring by the at least one first node, at least one second resource. The method further comprise configuring by the at least one first node, to perform at least one second operation by the at least one second node in the at least one second resource. The at least one second operation overrides the at least one first operation in an overlapping portion between the at least one first resource and the at least one second resource.

In an aspect, one or more of the at least one second resource and the at least one second operation are configured one of semi-statically and dynamically.

In an aspect, one or more of the at least one first resource and the at least one second resource is at least one of a time resource and a frequency resource.

In an aspect, the at least one first resource and the at least one second resource is one of non-overlapping, partial overlapping, and full overlapping.

In an aspect, one or more of the at least one first operation and the at least one second operation is one of downlink (DL), uplink (UL), and flexible (F).

In an aspect, the at least one first operation is configured through a common Time-Division Duplexing (TDD) configuration in Radio Resource Control (RRC) message.

In an aspect, the at least one second operation is configured by signalling by the at least one first node, a plurality of UE specific TDD configurations semi-statically using RRC message or Medium Access Control Information Element (MAC IE) to the at least one second node, and indicating a TDD configuration from the plurality of UE specific TDD configurations dynamically using MAC IE or Downlink Control Information (DCI).

In an aspect, the at least one second operation is configured in a per slot basis.

In an aspect, the at least one second operation is determined for at least one second node.

In an aspect, the at least one second operation is configured as a parameter in at least one of an RRC message, MAC IE, and at least one Downlink Control Information (DCI).

In an aspect, the at least one DCI comprises slot format indicator (SFI).

In an aspect, the parameter in the RRC message is within TDD-UL-DL-ConfigDedicated Information Element (IE).

In an aspect, the at least first node transmits an explicit indication to indicate to the at least one second node whether to use the parameter.

In an aspect, the at least one second node ignores TDD-UL-DL-ConfigDedicated IE in RRC message if the parameter is provided in RRC message.

In an aspect, the parameter indicates at least one of a number of DL operations at a beginning of a time unit; a number of DL operations at an end of the time unit; a number of UL operations at the beginning of the time unit; a number of UL operations at the end of the time unit; a number of F operations at the beginning of the time unit; a number of F operations at the end of the time unit; a number of DL operations after F operations at the beginning of the time unit; a number of DL operations before F operations at the end of the time unit; a number of UL operations after F operations at the beginning of the time unit; and a number of UL operations before F operations at the end of the time unit.

In an aspect, the time unit is at least one slot.

In an aspect, the number is at least one of number of slots and number of symbols.

In an aspect, the SFI comprises slot formats starting with UL symbols.

In an aspect, the at least one first node indicates at least one third resource to the at least one second node. The at least one third resource overlaps with the at least one second resource, one of partially and fully.

In an aspect, the at least one third resource is at least one of Channel State Information Reference Signal (CSI-RS), Control Resource Set (CORESET), and Sounding Reference Signal (SRS).

In an aspect, the at least one second resource comprises at least one of Physical Downlink Shared Channel (PDSCH) and Physical Uplink Shared Channel (PUSCH).

In an aspect, the at least one second operation is not performed in the resources when an overlap occurs between the at least one second resource and the at least one third resource.

In an aspect, the at least one second node performs the at least one first operation in the at least one third resource.

In an aspect, the at least one second node does not perform transmission and reception in the at least one third resource.

In an aspect, the indication of the at least one third resource is using one of zero power SRS pattern in PDSCH configuration, zero power CSI-RS pattern in PUSCH configuration, CORESET pattern in PUSCH configuration, and CORESET identity in PUSCH configuration.

The present invention further relates to a method of signalling in a cellular network. The method may comprise receiving, by at least one second node, at least one Reference Signal (RS) configuration from at least one first node. The method may further comprise transmitting, by the at least one second node, the at least one RS. The method may further comprise receiving, by the at least one second node, a pathloss from the at least one first node.

In an aspect, the at least one RS is Sounding Reference Signal (SRS).

In an aspect, the method may further comprise comprising, receiving an identity of the RS in which the pathloss is measured.

In an aspect, the method may further comprise comprising, adapting, by the at least one second node, a transmission power of UL signals based on the pathloss.

In an aspect, the UL signals comprises at least one of PUCCH, PUSCH, and SRS.

The present invention further relates to a method of signalling in a cellular network. The method may comprise configuring, by at least one first node, at least one first resource, to at least one second node. The method may further comprise configuring, by the at least one first node, to perform at least one first operation by the at least one second node in the at least one first resource. The method may further comprise determining by the at least one first node, at least one second resource. The method may further comprise configuring, by the at least one first node, the at least one second resource to the at least one second node using DCI. The at least one second resource overrides the at least one first resource. The method may further comprise configuring, by the at least one first node, to perform the at least one first operation in the at least one second resource.

In an aspect, the at least one first resource and the at least one second resource have different frequency domain resource allocation.

In an aspect, the at least one first operation is one of a grant free transmission in UL and a semi-persistent scheduling in DL.

In an aspect, configuring the at least one second resource comprises indicating an identity of the at least one first operation which has to be performed in the at least one second resource.

In an aspect, the identity is at least one of grant free transmission ID and active SPS ID.

In an aspect, the overriding is performed after a time duration from the configuration received.

In an aspect, the time duration is at least one of a number of symbols, a number of slots, millisecond, second, and number of at least one first resource.

The present invention further relates to a method of signalling in a cellular network. The method may comprise configuring, by at least one first node, plurality of Bandwidth Parts (BWPs) and plurality of Time-Division Duplexing (TDD) configurations to at least one second node. The method may further comprise associating, by the at least one first node, at least one BWP from the plurality of BWPs with at least one TDD configuration from the plurality of TDD configurations. The method may further comprise indicating, by the at least one first node, an at least one first BWP from the plurality of BWPs as active BWP to the at least one second node. The method may further comprise scheduling, by the at least one first node, based on the TDD configuration of the at least one first BWP.

In an aspect, the method further comprising receiving, by the at least one second node, an indication to switch from the at least one first BWP to an at least one second BWP from the plurality of BWPs, switching, by the at least one second node, from the at least one first BWP to the at least one second BWP, performing, by the at least one second node, at least one of transmission and reception in the at least one second BWP based on the TDD configuration of the at least one second BWP.

In an aspect, the indication to switch is received dynamically in DCI.

In an aspect, the associating at least one BWP with the at least one TDD configuration comprises one of: indicating, by the at least one first node, a dedicated TDD configuration for the at least one BWP using at least one of an RRC message and MAC IE, and indicating, by the at least one first node, a dedicated TDD configuration for an at least one second BWP along with an indication to switch to the at least one second BWP.

In an aspect, the dedicated TDD configuration for the at least one second BWP indicated along with the indication to switch, is selected from a plurality of TDD configurations provided to the at least one second node by the at least one first node.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary implementation of SBFD operation in non-overlapping sub-bands, in accordance with prior art.

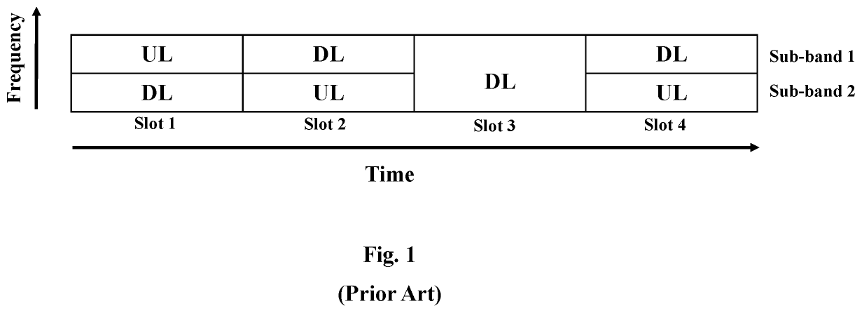

FIG. 2 illustrates an exemplary implementation of orthogonal frequency resources in same time resource, in accordance with prior art.

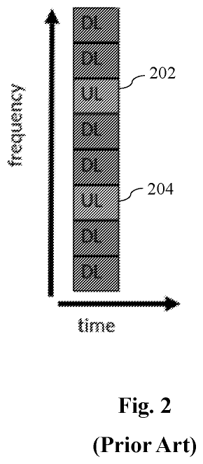

FIG. 3 illustrates SBFD operation in fully and partially overlapping sub-bands, in accordance with prior art.

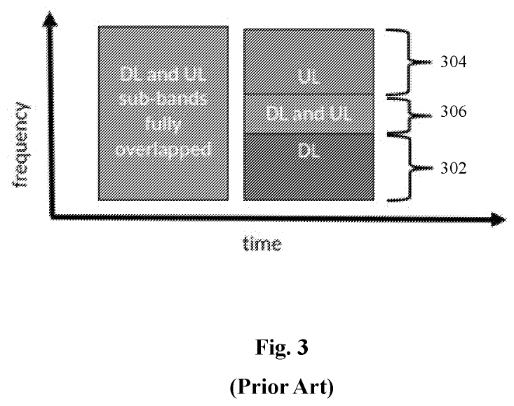

FIG. 4 illustrates TDD configurations to be provided to UEs, in accordance with prior art.

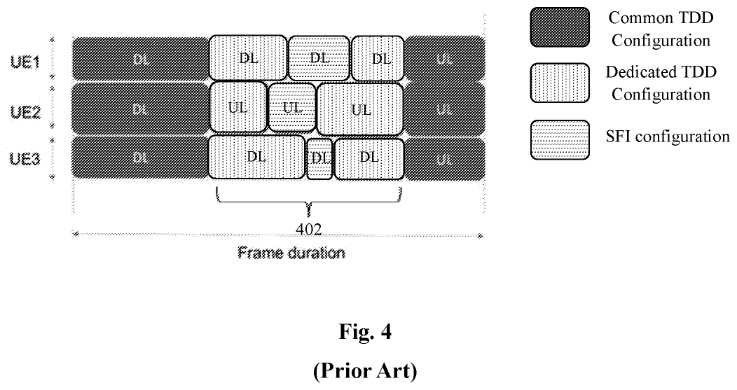

FIG. 5 illustrates an exemplary implementation of SBFD operation scheduled by a BS, in accordance with an embodiment of the present invention.

Embodiments of the present disclosure and their advantages are best understood by referring to the detailed description that follows. It should be appreciated that like reference numerals are used to identify like elements illustrated in one or more of the figures.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Present invention describes a method of signalling in a cellular network. In the cellular network, a Base Station (BS) may perform a downlink (DL) operation and an uplink (UL) operation in fully overlapping, partially overlapping, or orthogonal frequency resources, and same time resources. Each User Equipment (UE) may be provided with DL bandwidth parts (BWP) and UL BWP in a UE specific manner. The UE may perform DL operation and UL operation within the BWP configured as DL and UL, respectively.

The BS may allocate a first resource to a UE. The BS may be referred as a first node and the UE may be referred as a second node. The first resource may comprise a first time resource and a first frequency resource. The BS may configure the UE to perform a first operation in the first resource. The first operation may be downlink (DL), uplink (UL), and/or flexible (F) operation. Further, the BS may configure a second resource to the UE. The second resource may comprise a second time resource and a second frequency resource. The second resource may overlap the first resource partially or fully. The BS may further configure the UE to perform a second operation in the second resource. The second resource and the second operation are configured semi-statically or dynamically. The second operation may override the first operation when the first resource overlaps with the second resource. The overriding happens in an at least one resource of the overlapped resources.

The first operation and/or the second operation may be downlink (DL), uplink (UL), or flexible (F). In an implementation, the second operation may be DL, when the at least one first operation is UL and UL, when the at least one first operation is DL. The second operation may be DL or UL when the at least one first operation is F. The first operation may be configured through a common Time-Division Duplexing (TDD) configuration in Radio Resource Control (RRC) message.

The second operation may be configured by signalling a plurality of UE specific TDD configurations semi-statically to the UE and indicating a TDD configuration from the plurality of UE specific TDD configurations dynamically. The plurality of UE specific TDD configurations may be signalled using RRC message or Medium Access Control information element (MAC IE) and the TDD configuration may be indicated using MAC IE or Downlink Control Information (DCI). The second operation may be configured in a per slot basis.

The second operation may be configured through at least one of a parameter in RRC message, MAC IE or DCI. The BS may enhance an existing Information Element (IE), such as TDD-UL-DL-ConfigDedicated IE, in RRC message or may introduce a new parameter in the RRC message to configure the second operation. The UE, receiving enhanced IE or new parameter, use the indication to obtain the second operation. For e.g., the UE may ignore the TDD-UL-DL-ConfigDedicated IE in RRC message if the new parameter is provided in RRC message. The BS may transmit an explicit indication to indicate to the UE whether to use the enhanced IE or the existing IE.

Hence, a dedicated TDD configuration or SFI format overriding common TDD configuration provides more flexibility to the BS and allows SBFD operation in slot or symbol configured as DL, UL, or flexible by the common TDD configuration. The BS also indicates to the UE to override the common TDD configuration from the dedicated TDD configuration or SFI format. The UE supports TDD configurations and slot formats starting with DL resources, which restricts the SBFD operation to certain symbols or certain slot formats.

The configuration of second operation indicates a number of DL operations in a beginning of a time unit, a number of DL operations in an end of the time unit, a number of UL operations in the beginning of the time unit, a number of UL operations in the end of the time unit, a number of F operations in the beginning of the time unit, a number of F operations in the end of the time unit, a number of DL operations after F operations in the beginning of the time unit, a number of DL operations before F operations in the end of the time unit. a number of UL operations after F operations in the beginning of the time unit and a number of UL operations before F operations in the end of the time unit.

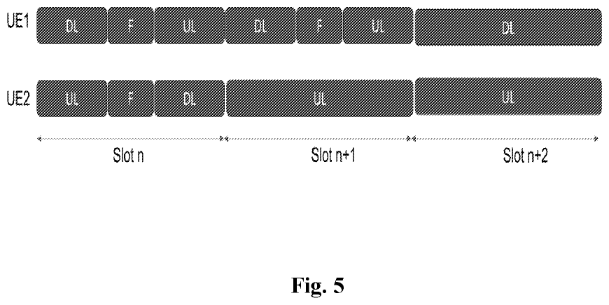

FIG. 5 illustrates configuration of the frame provided by the BS for the SBFD operation, in accordance with an embodiment of the present invention. The frame may be configured in three time slots such as n, n+1, and n+2. The n+2 time slot is configured for the DL operation for a first UE (UE 1) and the UL operation for a second UE (UE 2). The SBFD operation may be enabled for the entire time slot. Further, the UE 1 is configured with slot format of DL-F-UL and the UE 2 is configured with the UL operation in n+1 time slot. In such case,

SBFD is enabled only for symbols configured as DL for UE 1. Further, the UE 1 is configured with slot format DL-F-UL and UE2 is configured with UL-F-DL in time slot n. In that case, SBFD is enabled for the entire slot except for F symbols. The F symbols may be used as switching gaps. The F symbols can be configured as DL or UL using SFI format in DCI. The SFI formats starting with UL slots/symbols is needed to improve flexibility in configuring the SBFD operation. For e.g., if a slot is configured as DL for UE1 and F for UE2, by the cell common TDD configuration and UE specific TDD configuration, then the BS can perform SBFD in the beginning of the slot by configuring the slot with a SFI format staring with UL symbols to UE2. However, the current framework did not support SFI format starting with UL symbols. Therefore, based on current framework, the only option to enable SBFD at the start of the slot is to configure the entire slot as UL for UE2 and enable SBFD for the entire slot.

The BS may provide a choice between the two sets for selection to the UE. In an example, set 1 is the number of DL symbols in the beginning and the number of UL symbols in the end and set 2 is a combination of the number of DL symbols in the end, the number of UL symbols in the beginning, the number of F symbols in the beginning, the number of F symbols in the end, the number of DL symbols after F in the beginning, the number of DL symbols before F in the end, the number of UL symbols after F in the beginning, and the number of UL symbols before F in the end.

The BS may introduce a new parameter in TDD-UL-DL-ConfigDedicated IE or a new parameter in RRC message configured on a per slot basis. The configuration of RRC message may be defined as a combination of the number of UL symbols in the beginning, the number of DL symbols in the end, the number of F symbols in the beginning, the number of F symbols in the end, the number of DL symbols after F in the beginning, the number of DL symbols before F in the end, the number of UL symbols after F in the beginning, and the number of UL symbols before F in the end.

In the proposed method, the BS may allocate multiple BWPs to the UE, each associated with a dedicated TDD configuration. For providing more flexibility of scheduling and efficient utilization of available bandwidth for the SBFD operation, the BS may utilize different configurations of the dedicated TDD configuration. Whenever, the active BWP is switched the UE may use the TDD configuration associated with the active BWP. The BS may provide a set of TDD configurations in the RRC message and may dynamically inform the UE about a TDD configuration to be selected from the set. In such case, the BS may dynamically switch the TDD configuration along with switching the BWP.

In SBFD, a node can simultaneously perform DL transmission and UL reception, which can lead to collisions between various transmissions and receptions. E.g., channel state information-reference signal (CSI-RS) is a wide band signal, which the UE receives in resource elements across the BWP. In case of SBFD with non-overlapping sub-bands, the UL sub-band can overlap with BWP of a UE configured with CSI-RS reception, resulting in collision between CSI-RS and UL signal. Similar collision will occur for Sounding Reference Signal (SRS) at a UE, whose UL BWP overlaps with DL sub-band. The configuration should be adjusted such that collision is avoided in the REs carrying CSI-RS/SRS to maintain orthogonality for non-overlapping/partially overlapping SBFD. New rate matching patterns can be introduced to avoid such collisions.

The BS may introduce rate matching patterns for ensuring orthogonality DL and UL for SBFD. For example, the BS may provide a rate matching pattern for each RB and each symbol in PDSCH. The BS may provide an SRS rate matching pattern to the UE for reception of PDSCH. The SRS rate matching pattern may be provided by configuring zero power SRS patterns in the PDSCH configuration in RRC message. Activation and selection of the zero power SRS pattern may be provided to the UE using DCI. The REs corresponding to configured resources in zero power SRS pattern may be unavailable for PDSCH.

The BS may provide a CSI-RS rate matching pattern to the UE for reception of PUSCH. The CSI-RS rate matching may be provided by zero power CSI-RS patterns in the PUSCH configuration for the UE in RRC message. Activation and selection of the zero power CSI-RS pattern may be provided to the UE using DCI. The REs corresponding to configured resources in zero power CSI-RS pattern may be unavailable for PUSCH.

The BS may provide a Control Resource Set (CORESET) rate matching pattern to the UE for reception of PUSCH. The CORESET rate matching pattern may be provided by CORESET patterns and identities (IDs) in the PUSCH configuration for the UE in RRC message. Activation and selection of the CORESET ID may be provided to the UE using DCI. The REs corresponding to configured resources in CORESET pattern may be unavailable for PUSCH.

The BS may receive details related to a pathloss from the UE in UL. The BS may utilize reference signal for measurement of PUCCH and PUSCH power control in RRC message. The pathloss value may be provided to the UE for PUSCH and PUCCH power control. The UE may utilize the pathloss value when reference signal is used for measurement for

PUCCH and PUSCH power control in RRC message is indicated as SRS (SRS ID) or none.

The UE may utilize the pathloss value to adapt a transmission power of UL signals. The UL signals may comprise at least one of PUCCH, PUSCH, and SRS.

The BS may provide details about DL resources and UL resources to UEs based on traffic requirements. Latency in both DL and UL may be reduced using SBFD at the BS. The BS may enhance the SBFD operation for reducing latency and increase flexibility of resource allocation.

The BS may provide a provision to dynamically change the FDRA of the PUSCH transmission, configured semi-statically. The BS may signal the UE in DCI for a particular active grant free UL transmission configuration ID with new FDRA. For transmission of PUSCH, the UE may apply the updated FDRA after ‘N’ time units or time duration of the grant free transmission. The BS may further configure Semi-Persistent Scheduling (SPS) for multiple SPS in RRC message. Activation or de-activation of the SPS configuration may be provided to the UE using DCI. The BS may signal the UE in DCI for a particular active SPS ID with new FDRA. For reception of PDSCH, the UE may apply the updated FDRA after ‘N’ time units or time duration of SPS transmission.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

1. A method of signalling in a cellular network, comprising:
allocating, by at least one first node, at least one first resource to at least one second node;
configuring, by the at least one first node, to perform at least one first operation by the at least one second node in the at least one first resource;
configuring, by the at least one first node, at least one second resource to the at least one second node; and
configuring, by the at least one first node, to perform at least one second operation by the at least one second node in the at least one second resource, wherein the at least one second operation overrides the at least one first operation in an overlapping portion between the at least one first resource and the at least one second resource.

2. The method as claimed in claim 1, wherein one or more of the at least one second resource and the at least one second operation are configured one of semi-statically and dynamically.

3. The method as claimed in claim 1, wherein one or more of the at least one first resource and the at least one second resource is at least one of a time resource and a frequency resource.

4. The method as claimed in claim 1, wherein the at least one first resource and the at least one second resource is one of non overlapping, partial overlapping, and full overlapping.

5. The method as claimed in claim 1, wherein one or more of the at least one first operation and the at least one second operation is one of downlink (DL), uplink (UL), and flexible (F).

6. The method as claimed in claim 1, wherein the at least one first operation is configured through a common Time-Division Duplexing (TDD) configuration in Radio Resource Control (RRC) message.

7. The method as claimed in claim 1, wherein the at least one second operation is configured by:
signalling by the at least one first node, a plurality of UE specific TDD configurations semi-statically using RRC message or Medium Access Control Information Element (MAC IE) to the at least one second node, and
indicating a TDD configuration from the plurality of UE specific TDD configurations dynamically using MAC IE or Downlink Control Information (DCI).

8. The method as claimed in claim 1, wherein the at least one second operation is configured in a per slot basis.

9. The method as claimed in claim 1, wherein the at least one second operation is determined for at least one second node.

10. The method as claimed in claim 1, wherein the at least one second operation is configured as a parameter in at least one of an RRC message, MAC IE, and at least one Downlink Control Information (DCI).

11. The method as claimed in claim 10, wherein the at least one DCI comprises slot format indicator (SFI).

12. The method as claimed in claim 10, wherein the parameter in the RRC message is within TDD-UL-DL-ConfigDedicated Information Element (IE).

13. The method as claimed in claim 10, wherein the at least first node transmits an explicit indication to indicate to the at least one second node whether to use the parameter.

14. The method as claimed in claim 10, wherein the at least one second node ignores TDD-UL-DL-ConfigDedicated IE in RRC if the parameter is provided in RRC message.

15. The method as claimed in claim 10, wherein the parameter indicates at least one of:
a number of DL operations at a beginning of a time unit;
a number of DL operations at an end of the time unit;
a number of UL operations at the beginning of the time unit;
a number of UL operations at the end of the time unit;
a number of F operations at the beginning of the time unit;
a number of F operations at the end of the time unit;
a number of DL operations after F operations at the beginning of the time unit;
a number of DL operations before F operations at the end of the time unit;
a number of UL operations after F operations at the beginning of the time unit; and
a number of UL operations before F operations at the end of the time unit.

16. The method as claimed in claim 15, wherein the time unit is at least one slot.

17. The method as claimed in claim 15, wherein the number is at least one of number of slots and number of symbols.

18. The method as claimed in claim 11, wherein the SFI comprises slot formats starting with UL symbols.

19. The method as claimed in claim 1, wherein the at least one first node indicates at least one third resource to the at least one second node, and wherein the at least one third resource overlaps with the at least one second resource, one of partially and fully.

20. The method as claimed in claim 19, wherein the at least one third resource is at least one of Channel State Information Reference Signal (CSI-RS), Control Resource Set (CORESET), and Sounding Reference Signal (SRS).

21. The method as claimed in claim 19, wherein the at least one second resource comprises at least one of Physical Downlink Shared Channel (PDSCH) and Physical Uplink Shared Channel (PUSCH).

22. The method as claimed in claim 1 and claim 19, wherein the at least one second operation is not performed in the resources when an overlap occurs between the at least one second resource and the at least one third resource.

23. The method as claimed in claim 19, wherein the at least one second node performs the at least one first operation in the at least one third resource.

24. The method as claimed in claim 19, wherein the at least one second node does not perform transmission and reception in the at least one third resource.

25. The method as claimed in claim 19, wherein the indication of the at least one third resource is using one of:
zero power SRS pattern in PDSCH configuration;
zero power CSI-RS pattern in PUSCH configuration;
CORESET pattern in PUSCH configuration; and
CORESET identity in PUSCH configuration.

26. A method of signalling in a cellular network, comprising:
receiving, by at least one second node, at least one Reference Signal (RS) configuration from at least one first node;
transmitting, by the at least one second node, the at least one RS; and
receiving, by the at least one second node, details related to a pathloss from the at least one first node.

27. The method as claimed in claim 26, wherein the at least one RS is Sounding Reference Signal (SRS).

28. The method as claimed in claim 26, further comprising, receiving an identity of the RS in which the pathloss is measured.

29. The method as claimed in claim 26, further comprising, adapting, by the at least one second node, a transmission power of UL signals based on the pathloss.

30. The method as claimed in claim 29, wherein the UL signals comprises at least one of PUCCH, PUSCH, and SRS.

31. A method of signalling in a cellular network, comprising:
configuring, by at least one first node, at least one first resource, to at least one second node;
configuring, by the at least one first node, to perform at least one first operation by the at least one second node in the at least one first resource;
determining by the at least one first node, at least one second resource;
configuring, by the at least one first node, the at least one second resource to the at least one second node using Downlink Control Information (DCI), wherein the at least one second resource overrides the at least one first resource; and
configuring, by the at least one first node, to perform the at least one first operation in the at least one second resource.

32. The method as claimed in claim 31, wherein the at least one first resource and the at least one second resource have different frequency domain resource allocation.

33. The method as claimed in claim 31, wherein the at least one first operation is one of a grant free transmission in uplink (UL) and a semi-persistent scheduling in downlink (DL).

34. The method as claimed in claim 31, wherein configuring the at least one second resource comprises indicating an identity of the at least one first operation which has to be performed in the at least one second resource.

35. The method as claimed in claim 34, wherein the identity is at least one of grant free transmission ID and active SPS ID.

36. The method as claimed in claim 31, wherein the overriding is performed after a time duration from the configuration received.

37. The method as claimed in claim 36, wherein the time duration is at least one of a number of symbols, a number of slots, millisecond, second, and number of at least one first resource.

38. A method of signalling in a cellular network, comprising:
configuring, by at least one first node, plurality of Bandwidth Parts (BWPs) and plurality of Time-Division Duplexing (TDD) configurations to at least one second node,
associating, by the at least one first node, at least one BWP from the plurality of BWPs with at least one TDD configuration from the plurality of TDD configurations;
indicating, by the at least one first node, an at least one first BWP from the plurality of BWPs as active BWP to the at least one second node; and
scheduling, by the at least one first node, based on the TDD configuration of the at least one first BWP.

39 The method as claimed in claim 38, further comprises
receiving, by the at least one second node, an indication to switch from the at least one first BWP to an at least one second BWP from the plurality of BWPs;
switching, by the at least one second node, from the at least one first BWP to the at least one second BWP; and
performing, by the at least one second node, at least one of transmission and reception in the at least one second BWP based on the TDD configuration of the at least one second BWP.

40. The method as claimed in claim 39, wherein the indication to switch is received dynamically in Downlink Control Information (DCI).

41. The method as claimed in claim 38, wherein the associating at least one BWP with the at least one TDD configuration comprises one of:
indicating, by the at least one first node, a dedicated TDD configuration for the at least one BWP using at least one of an RRC message and MAC IE, and
indicating, by the at least one first node, a dedicated TDD configuration for an at least one second BWP along with an indication to switch to the at least one second BWP.

42. The method as claimed in claim 41, wherein the dedicated TDD configuration for the at least one second BWP indicated along with the indication to switch, is selected from a plurality of TDD configurations provided to the at least one second node by the at least one first node.
